(19) United States
(12) Patent Application Publication
(10) Pub. No.: US 2026/0339708 A1
(43) Pub. Date: Oct. 29, 2026

(54) INFORMATION PROCESSING METHOD BASED ON LARGE MODEL, ELECTRONIC DEVICE, AND STORAGE MEDIUM

(71) Applicant: Beijing Baidu Netcom Science Technology Co., Ltd., Beijing (CN)

(72) Inventors: Haifeng MENG, Beijing (CN); Ying WANG, Beijing (CN); Zaishen YANG, Beijing (CN); Li ZHANG, Beijing (CN); Muhan HE, Beijing (CN); Youyuan FAN, Beijing (CN); Jia ZHANG, Beijing (CN); Xu RONG, Beijing (CN); Haijun LIU, Beijing (CN); Shaowei LIANG, Beijing (CN); Shujie MI, Beijing (CN); Tao ZHANG, Beijing (CN); Honghai WANG, Beijing (CN)

(21) Appl. No.: 19/706,899

(22) Filed: Jun. 12, 2026

(30) Foreign Application Priority Data
Jul. 31, 2025 (CN) 202511072513.8

(51) Int. Cl. G06F 9/48

(52) U.S. Cl. CPC G06F 9/4881

(57) ABSTRACT

An information processing method based on a large model, an electronic device, and a storage medium are provided, which relate to the field of artificial intelligence technology, and in particular to technical fields such as large models, intelligent question answering, intelligent search, and smart healthcare. The information processing method based on a large model includes: performing task orchestration on a demand information related to a target object to obtain a task orchestration strategy including a plurality of initial tasks; updating at least one initial task in the task orchestration strategy according to an interactive operation of the target object in a process of executing the task orchestration strategy using the large model, so as to obtain a target task; and determining a feedback information matching a demand intent of the target object according to a target execution result determined by executing the target task using the large model.

This application claims the benefit of priority to Chinese Patent Application No. 202511072513.8, filed on Jul. 31, 2025. The entire contents of this application are hereby incorporated herein by reference.

### TECHNICAL FIELD

The present disclosure relates to a field of artificial intelligence technology, in particular to technical fields such as large models, intelligent question answering, intelligent search, and smart healthcare, and more specifically relates to an information processing method based on a large model, an electronic device, and a storage medium.

### BACKGROUND

A Large Language Model (LLM) is a model constructed based on deep learning algorithms and capable of executing generative tasks based on natural language understanding. A large language model may be used to process a question input by a user and satisfy the user demand by generating response content expressed in natural language.

### SUMMARY

The present disclosure provides an information processing method based on a large model, an electronic device, and a storage medium.

According to an aspect of the present disclosure, an information processing method based on a large model is provided, including: performing task orchestration on a demand information related to a target object to obtain a task orchestration strategy including a plurality of initial tasks; updating at least one of the plurality of initial tasks in the task orchestration strategy according to an interactive operation of the target object in a process of executing the task orchestration strategy using the large model, so as to obtain a target task; and determining a feedback information matching a demand intent of the target object according to a target execution result determined by executing the target task using the large model.

According to another aspect of the present disclosure, an electronic device is provided, including: at least one processor; and a memory communicatively connected to the at least one processor, where the memory stores instructions executable by the at least one processor, and the instructions, when executed by the at least one processor, are used to cause the at least one processor to perform the method provided according to embodiments of the present disclosure.

According to another aspect of the present disclosure, a non-transitory computer-readable storage medium having computer instructions therein is provided, where the computer instructions are used to cause a computer to perform the method provided according to embodiments of the present disclosure.

It should be understood that the content described in this section is not intended to identify key or essential features of embodiments of the present disclosure, nor is it intended to limit the scope of the present disclosure. Other features of the present disclosure will become easily understood through the following description.

### BRIEF DESCRIPTION OF THE DRAWINGS

The accompanying drawings are provided for better understanding of the solutions and do not constitute any limitation to the present disclosure. In the accompanying drawings:

FIG. 1 schematically shows an exemplary system architecture to which an information processing method and apparatus based on a large model according to embodiments of the present disclosure may be applied;

FIG. 2 schematically shows a flowchart of an information processing method based on a large model according to an embodiment of the present disclosure;

FIG. 3 schematically shows a schematic diagram of a principle of a task orchestration strategy according to an embodiment of the present disclosure;

FIG. 4 schematically shows a schematic diagram of a principle of an information processing method based on a large model according to an embodiment of the present disclosure;

FIG. 5 schematically shows a system architecture diagram of an information processing system according to an embodiment of the present disclosure;

FIG. 6 schematically shows a flowchart of an information processing method based on a large model according to another embodiment of the present disclosure;

FIG. 7 schematically shows a block diagram of an information processing apparatus based on a large model according to an embodiment of the present disclosure;

FIG. 8 schematically shows a structural block diagram of an artificial intelligence agent according to an embodiment of the present disclosure; and

FIG. 9 shows a schematic block diagram of an example electronic device for implementing an information processing method based on a large model according to embodiments of the present disclosure.

### DETAILED DESCRIPTION OF EMBODIMENTS

Exemplary embodiments of the present disclosure are described below with reference to the accompanying drawings, which include various details of embodiments of the present disclosure to facilitate understanding, and which should be regarded as illustrative only. Accordingly, those of ordinary skill in the art will recognize that various changes and modifications may be made to embodiments described herein without departing from the scope and spirit of the present disclosure. Likewise, for clarity and conciseness, descriptions of well-known functions and structures are omitted in the following description.

In the technical solutions of the present disclosure, the acquisition, storage, application, and the like of user personal information involved comply with relevant laws and regulations, necessary confidentiality measures are adopted, and public order and good morals are not violated.

For the question-answering interaction between a large model and a user, due to the long time taken by the large model to execute a text generation task and the large discrepancy between the generated response content and the actual demand intent of the user, the user may be caused to repeatedly modify the question according to the response content or click a regeneration option to instruct the large model to regenerate new response content. As a result, a long waiting time for the user arises in the intelligent question-answering interaction between the large model and the user, and a large amount of redundant computational overhead is easily caused on computing devices such as servers deploying the large model.

Embodiments of the present disclosure provide an information processing method and apparatus based on a large model, an electronic device, and a storage medium. The information processing method based on a large model includes: performing task orchestration on a demand information related to a target object to obtain a task orchestration strategy including a plurality of initial tasks; updating at least one initial task in the task orchestration strategy according to an interactive operation of the target object in a process of executing the task orchestration strategy using a large model, so as to obtain a target task; and determining a feedback information matching a demand intent of the target object according to a target execution result determined by executing the target task using the large model.

According to embodiments of the present disclosure, by performing task orchestration based on the demand information of the target object, an execution result of the plurality of initial tasks in the task orchestration strategy may satisfy a demand attribute represented by the demand information. In a process of executing the plurality of initial tasks in the task orchestration strategy using the large model, the initial tasks in the task orchestration strategy may be synchronously updated according to the interactive operation of the target object, thereby enabling dynamic adjustment of the initial tasks in the task orchestration strategy according to real-time demands represented by the user's interactive operation while the large model is executing the initial tasks. This avoids requiring the user to wait until all initial tasks in the task orchestration strategy have been completed before updating the demand information to obtain response content that satisfies the user's actual demand. Moreover, the target execution result obtained by updating according to the intent of the interactive operation may satisfy the real-time demand of the target object. Accordingly, by adjusting in real time the task orchestration logic generated for the actual demand of the target object, a target execution result matching the actual demand of the target object may be determined. As a result, the feedback information determined according to the target execution result may satisfy the actual demand of the target object even before the execution of the task orchestration logic is completed, thereby improving generation efficiency and quality of the feedback information, reducing redundant computational overhead of computing devices deploying the large model, and enhancing user satisfaction and user experience.

FIG. 1 schematically shows an exemplary system architecture to which an information processing method and apparatus based on a large model according to embodiments of the present disclosure may be applied.

It should be noted that FIG. 1 is merely an example of a system architecture to which embodiments of the present disclosure may be applied, so as to help those skilled in the art understand the technical content of the present disclosure, and does not mean that embodiments of the present disclosure cannot be applied to other devices, systems, environments, or scenarios. For example, in another embodiment, an exemplary system architecture to which the information processing method and apparatus based on a large model may be applied may include a terminal device, and the terminal device may implement the information processing method and apparatus based on a large model provided by embodiments of the present disclosure without interacting with a server.

As shown in FIG. 1, a system architecture 100 according to such embodiments may include a first terminal device 101, a second terminal device 102, a third terminal device 103, a network 104, and a server 105. The network 104 serves as a medium for providing communication links between the first terminal device 101, the second terminal device 102, the third terminal device 103, and the server 105. The network 104 may include various connection types, such as wired and/or wireless communication links, or the like.

The first terminal device 101, the second terminal device 102, and the third terminal device 103 may be used by users to interact with the server 105 via the network 104 to receive or send messages, etc. The first terminal device 101, the second terminal device 102, and the third terminal device 103 may be installed with various communication client applications, such as knowledge reading applications, web browser applications, search applications, instant messaging tools, email clients, and/or social networking platform software (for example only).

The first terminal device 101, the second terminal device 102, and the third terminal device 103 may be various electronic devices having display screens and supporting web browsing, including but not limited to smartphones, tablet computers, laptop computers, desktop computers, and the like.

The server 105 may be a server providing various services, such as a backend management server that provides support for content browsed by users using the first terminal device 101, the second terminal device 102, and the third terminal device 103 (for example only). The backend management server may analyze and process received user requests and other data, and feed processing results (e.g., web pages, information, or data acquired or generated according to user requests) back to the terminal devices.

It should be noted that the information processing method based on a large model provided by embodiments of the present disclosure may generally be performed by the first terminal device 101, the second terminal device 102, or the third terminal device 103. Accordingly, the information processing apparatus based on a large model provided by embodiments of the present disclosure may be disposed in the first terminal device 101, the second terminal device 102, or the third terminal device 103.

Alternatively, the information processing method based on a large model provided by embodiments of the present disclosure may generally be performed by the server 105. Accordingly, the information processing apparatus based on a large model provided by embodiments of the present disclosure may generally be disposed in the server 105. The information processing method based on a large model provided by embodiments of the present disclosure may also be performed by a server or server cluster different from the server 105 and capable of communicating with the first terminal device 101, the second terminal device 102, the third terminal device 103, and/or the server 105. Accordingly, the information processing apparatus based on a large model provided by embodiments of the present disclosure may also be disposed in a server or server cluster different from the server 105 and capable of communicating with the first terminal device 101, the second terminal device 102, the third terminal device 103, and/or the server 105.

It should be understood that the numbers of terminal devices, networks, and servers in FIG. 1 are merely illustrative. Any number of terminal devices, networks, and servers may be provided according to implementation requirements.

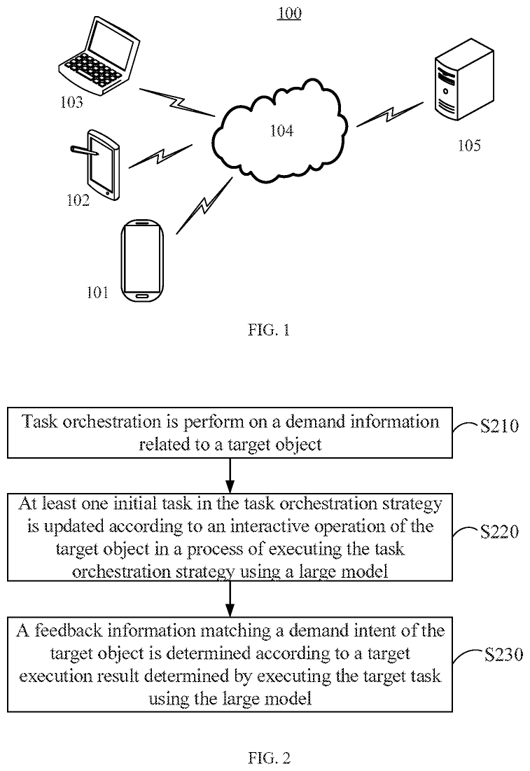

FIG. 2 schematically shows a flowchart of an information processing method based on a large model according to an embodiment of the present disclosure.

As shown in FIG. 2, the information processing method based on a large model includes operation S210 to operation S230.

In operation S210, task orchestration is performed on a demand information related to a target object to obtain a task orchestration strategy including a plurality of initial tasks.

In operation S220, at least one initial task in the task orchestration strategy is updated according to an interactive operation of the target object in a process of executing the task orchestration strategy using a large model, so as to obtain a target task.

In operation S230, a feedback information matching a demand intent of the target object is determined according to a target execution result determined by executing the target task using the large model.

According to embodiments of the present disclosure, the demand information may be information representing the demand of the target object, such as a question text, a query information, or the like input by the target object. The demand information may include information of any data type, such as text, image, audio, etc. The specific data type of the demand information is not limited in embodiments of the present disclosure.

According to embodiments of the present disclosure, performing task orchestration on the demand information may include processing the demand information based on a deep learning model to generate a task orchestration strategy including a plurality of initial tasks and dependencies among the plurality of initial tasks. The initial tasks may include any type of data processing tasks, such as information retrieval, image recognition, data calculation, or the like. The dependencies may represent execution logic among different initial tasks.

According to embodiments of the present disclosure, the plurality of initial tasks may be executed using a large model according to the dependencies in the task orchestration strategy. For example, the large model may execute a first initial task, namely an “image segmentation task”, to perform image segmentation on an image in the demand information, so as to obtain a segmented image region of building A. The image region of building A may be an initial execution result of the first initial task, namely the “image segmentation task”. After the image region of building A is obtained, a second initial task, namely a “target recognition task”, having a dependency on the first initial task may be determined based on the dependencies in the task orchestration strategy. The large model may invoke a target recognition tool to execute the second initial task, and determine that an object type identified from the image region of building A is “stadium A”.

In some embodiments, the task orchestration strategy may be represented by a topological structure such as a task chain or task tree including a plurality of initial tasks. The topological structure representing the task orchestration strategy may include task nodes representing the initial tasks and edge relationships representing the dependencies. Accordingly, the large model may clearly execute the plurality of initial tasks according to the execution logic indicated by the dependencies in the task orchestration strategy, such that the task orchestration logic may be executed using the large model.

According to embodiments of the present disclosure, the large model may be a trained large language model. The large model may process multi-modal data such as text, speech, images, or the like, based on a large scale of model parameters so as to execute the initial tasks. It should be noted that one or more large models may be involved in embodiments of the present disclosure, and the number of large models is not limited in embodiments of the present disclosure.

According to embodiments of the present disclosure, executing the task orchestration logic using the large model may include executing the plurality of initial tasks according to the dependencies indicated by the task orchestration logic using a computing unit deploying model parameters of the large model. Execution of the task orchestration logic using the large model may be a process in which the computing unit performs data processing on the initial tasks.

In some embodiments, in a process of executing the task orchestration logic using the large model, the feedback information matching the demand of the target object may not yet have been output. The target object may perform any type of interactive operation, such as an input operation, in the process of executing the initial tasks using the large model. An operation information such as an operation type of the interactive operation and an input information carried by the interactive operation may represent a real-time demand attribute of the target object in the process of executing the task orchestration logic.

In some embodiments, updating at least one initial task in the task orchestration logic according to the interactive operation of the target object may include updating task attribute parameters of the initial task based on the operation information carried by the interactive operation of the target object, so as to obtain the target task. For example, tool attribute parameters, such as a tool name and tool parameters of a tool resource involved in the execution of the initial task, may be updated. However, embodiments of the present disclosure are not limited thereto. The task attribute parameters may further include parameters for controlling a task execution result, such as a reference knowledge domain related to the initial task, a style attribute, and a data format of an output result.

For example, updating the initial task may include updating a prompt for executing an initial task “information retrieval” using the large model, based on “please refer to knowledge in the medical domain” input in the interactive operation, and executing a target search task based on a new prompt “search knowledge in the medical domain”.

In some embodiments, updating at least one initial task in the task orchestration logic according to the interactive operation of the target object may further include updating the dependencies among the plurality of initial tasks in the task orchestration strategy. For example, a serial execution logic of initial task 1 to initial task 6 in the task orchestration strategy may be modified, according to the operation information indicated by the interactive operation, into a first task chain in which initial task 1 to initial task 4 are executed in parallel and a second task chain in which initial task 5 to initial task 6 are executed in parallel. Thus, the dependencies in the task orchestration logic may be modified based on the interactive operation to adjust execution logic and execution order among the plurality of initial tasks, such that the large model may execute a plurality of tasks in a plurality of task chains based on a parallel model, thereby improving the generation efficiency of the feedback information. It should be understood that the initial task with the updated dependencies may be regarded as a target task. The feedback information may be determined based on a target execution result of the target task and an initial execution result of the initial task.

In some embodiments, updating at least one initial task in the task orchestration logic according to the interactive operation of the target object may further include updating both the task attribute parameter of the initial task and the dependencies among the initial tasks in the task orchestration logic, which will not be described in detail in embodiments of the present disclosure.

According to embodiments of the present disclosure, by updating at least one initial task in the task orchestration logic according to the interactive operation of the target object, the updated target task may satisfy the actual demand indicated by the interactive operation. Accordingly, the target execution result obtained by executing the target task in the task orchestration logic using the large model may satisfy the actual demand of the target object, such that the feedback information determined according to the target execution result may match the real-time demand of the target object. Furthermore, this avoids the situation where the target object is required to input modified demand information to obtain a new response using the large model only after the task orchestration logic has been completely executed, thereby reducing the waiting time for the target object to obtain satisfactory feedback information, enhancing user experience, and reducing computational overhead of the computing device deploying the large model.

In some embodiments, the information processing method based on a large model may further include: pushing at least one of the task orchestration strategy and the initial execution result of the initial task to the target object.

In an example, the task orchestration strategy may be pushed to the target object, and a directed acyclic graph representing the plurality of initial tasks and the dependencies among the plurality of initial tasks in the task orchestration strategy may be displayed. The target object may perform an interactive operation on the task nodes representing the initial tasks and the edge relationships representing the dependencies in the directed acyclic graph, so as to input the operation information.

In an example, the execution result obtained by executing the initial task in the task orchestration strategy using the large model may also be pushed to the target object. For example, a plurality of landscape images of City A retrieved by an initial task “image retrieval task” may be pushed to the target object. The target object may remove a specified landscape image from the displayed landscape images to reduce an amount of data to be processed in a process of executing subsequent initial tasks or target tasks in the task orchestration strategy, thereby reducing the computational overhead for generating the feedback information, reducing degradation in the degree of matching between the generated feedback information and the actual demand of the target object caused by processing landscape images not needed by the target object, and enhancing user experience.

In some embodiments, both the initial execution result and the task orchestration strategy may be pushed to the target object, such that the target object may flexibly and dynamically adjust and orchestrate the tasks to be executed by the large model. As a result, the task orchestration strategy may accurately satisfy the demand of the target object, improve the degree of matching between the feedback information and the demand intent of the target object, and enhance user experience.

According to embodiments of the present disclosure, the first obtaining module may be used to perform semantic understanding on the demand information using the large model to obtain a demand intent; and perform task orchestration based on the demand intent to obtain the task orchestration strategy.

According to embodiments of the present disclosure, the demand intent may represent a demand attribute of the target object. For example, the demand intent may be an unstructured natural language description information such as “generate a news article with a campus sports meet as a theme”. For another example, the demand intent may be structured data, for example, the demand intent may include a plurality of intent keywords expressed based on a table. By performing intent understanding on the demand information using the large model, it is possible to correct semantically ambiguous portions in the demand information or complete missing information, such that the obtained demand intent may accurately represent the actual demand attribute of the target object. This improves accuracy of a subsequently determined task orchestration strategy, reduces degradation in the degree of matching between the feedback information and the demand of the target object caused by missing tasks, and thus enhances user experience.

In some embodiments, performing semantic understanding on the demand information using the large model to obtain the demand intent may further include: determining initial tasks respectively corresponding to a plurality of intent contents in a structured demand intent, and then determining the task orchestration strategy based on a preset dependency.

In some embodiments, performing semantic understanding on the demand information using the large model to obtain the demand intent may further include: processing the demand information and an object attribute information of the target object using the large model, and performing demand intent understanding by fusing the demand information and the target object attribute such as preferences and habits represented by the object attribute information using the large model, so as to obtain a demand intent satisfying the actual demand of the target object, thereby enhancing user experience.

In some embodiments, performing semantic understanding on the demand information using the large model to obtain the demand intent may further include: performing semantic understanding on the demand information using the large model based on an object attribute knowledge graph, so as to obtain the demand intent.

According to embodiments of the present disclosure, an object attribute node in the object attribute knowledge graph represents a historical interaction information or an object preference attribute of the target object. The historical interaction information may represent browsing interaction behaviors, bookmarking interaction behaviors, liking interaction behaviors, search interaction behaviors, or the like performed by the target object in a historical period. However, embodiments of the present disclosure are not limited thereto. The historical interaction information may further include context content input by the target object, historical dialogue content between the target object and the large model, or the like. The object preference attribute may include an attribute information determined based on a preference selection operation of the target object, such as a sports preference attribute, a medical knowledge preference attribute, or the like. The specific type and generation manner of the object preference attribute are not limited in embodiments of the present disclosure.

According to embodiments of the present disclosure, by constructing the object knowledge graph based on the historical interaction information and the object preference attribute, personalized preferences or habits of the target object may be represented by entities, and associations among different types of personalized preferences or habits may be represented by edges. Accordingly, a personalized potential demand attribute of the target object may be represented in a structured manner through the object attribute knowledge graph. By performing semantic understanding on the demand information using the large model based on the object attribute knowledge graph, the large model may clearly understand the potential demand attribute of the target object based on the structured representation of personalized preferences. As a result, the demand intent contained in the demand information may be understood by the large model in combination with the personalized preference attribute, such that the demand intent may accurately represent the actual intent of the target object. This improves the rationality and adaptability of subsequent task orchestration strategy, and user experience may be enhanced through execution of the updated task orchestration logic.

In some embodiments, the demand intent includes an expected-time intent representing a time expected by the target object to obtain the feedback information. The expected-time intent may represent an intent related to the time of obtaining the feedback information, such as a time instant, a duration, or a time period expected to obtain the feedback information. For example, the expected-time intent may be “20 minutes later” or “11:00 AM on day y of month x, 2025”. The demand intent including the expected-time intent may be obtained by performing intent understanding on the demand information using a first large model.

In some embodiments, performing task orchestration based on the demand intent to obtain the task orchestration strategy may include: performing task orchestration on the demand content of the demand intent using the first large model based on a latency prompt information determined from the expected-time intent, so as to obtain the task orchestration strategy.

According to embodiments of the present disclosure, the latency prompt information may be used to prompt the large model that a strategy execution duration of executing the task orchestration logic and outputting the feedback information needs to meet the time instant or duration expected by the target object for obtaining the feedback information.

For example, the latency prompt information may include “output a PPT file related to this month's work report within 20 minutes”.

In some embodiments, the task orchestration may be performed by the first large model according to the demand intent, and the task orchestration strategy may be executed using a second large model. The first large model and the second large model may be different large models having different model parameters. Through collaboration among multiple different large models to respectively perform the task orchestration and execute the task orchestration strategy, different types of tasks may be executed based on different model capabilities of different large models, thereby improving the efficiency and quality of generation and execution of the task orchestration strategy based on the collaboration among multiple large models. As a result, the degree of matching between the feedback information and the target object may be improved, thereby enhancing user experience.

In some embodiments, the strategy execution duration for the second large model to execute the task orchestration strategy to obtain the feedback information matches the expected-time intent. For example, the duration required by the second large model to obtain the feedback information by executing the task orchestration strategy output by the first large model based on the latency prompt information may match the time demand attribute represented by the expected-time intent, such as the time instant, duration, or time period expected for obtaining the feedback information. Accordingly, the first large model may output a task orchestration strategy adapted for the second large model to output the feedback information according to the expected-time intent, so as to meet the time demand of the target object for obtaining the feedback information, thereby satisfying diverse practical user demands and enhancing user experience.

In some embodiments, the information processing method based on a large model may further include: performing semantic understanding on respective model description information of a plurality of candidate large models using the first large model based on a task attribute information of the initial task, and determining a second large model for executing the initial task from the plurality of candidate large models.

According to embodiments of the present disclosure, the model description information represents a model performance attribute of the candidate large model. For example, the model performance attribute may include a model performance metric of the candidate large model, such as accuracy, average latency, computational overhead cost, and the like. In addition, the model performance attribute may further include a domain to which the candidate large model is adapted, such as a medical domain, an education domain, an engineering construction domain, and other types of domains. As another example, the model performance attribute may further indicate a scenario to which the candidate large model is adapted, such as an intelligent search scenario, a script editing scenario, a marketing copywriting scenario, and the like.

In some embodiments, the model performance attribute may further indicate a model performance metric used for evaluating the computational overhead of the candidate large model, such as a scale of the model parameter size of the candidate large model.

According to embodiments of the present disclosure, by performing semantic understanding on the model description information of each of the plurality of candidate large models based on the task attribute information of the plurality of initial tasks, the first large model may fully understand the degree of matching between the model performance of the candidate large model and the performance requirements for executing the initial tasks. Consequently, the second model determined from the candidate large models for each initial task may accurately match the task attribute information, such as task requirement scenarios and task execution parameters, related to the initial tasks in the task orchestration strategy. As a result, the execution result output based on the task orchestration strategy may be further adapted to the demand intent represented by the demand information, thereby reducing the frequency of interactive operations performed by the target object, improving the degree of matching between the feedback information and the demand intent of the target object, and enhancing user experience.

In an embodiment, the plurality of initial tasks in the orchestration strategy may be executed by different second large models. Accordingly, a plurality of different large models may be scheduled to respectively execute different initial tasks based on the task orchestration strategy output by the first large model, thereby improving the execution efficiency of the initial tasks.

In some embodiments, the orchestration strategy includes a plurality of task topologies having dependencies on a specified initial task, and the interactive operation is related to a first task topology among the plurality of task topologies.

According to embodiments of the present disclosure, a task topology may be represented in any topological form, such as a task chain or a task tree. A plurality of initial tasks within a task topology have dependencies, and a task execution process between different task topologies may be represented through the dependency between each task topology and the specified initial task.

FIG. 3 schematically shows a schematic diagram of a principle of a task orchestration strategy according to an embodiment of the present disclosure.

As shown in FIG. 3, the task orchestration strategy in such embodiments may be a file task orchestration strategy 300 for generating a presentation file. The first large model may perform task orchestration on the demand information input by a target object, namely, “generate a presentation file introducing tourist attractions in City A”, so as to obtain the file task orchestration strategy 300. The file task orchestration strategy 300 may include a plurality of initial tasks, which may be represented by the circular elements shown in FIG. 3. The plurality of initial tasks include a first initial task to a sixth initial task. The first initial task represents a presentation outline generation task, the second initial task represents an image material retrieval task, the third initial task represents an image material editing task, the fourth initial task represents a tourist-attraction introduction text retrieval task, the fifth initial task represents a semantic fusion task for tourist-attraction introduction texts, and the sixth initial task represents a presentation file creation task.

The file task orchestration strategy 300 may include two different task topologies having dependencies on the first initial task, namely, a first task topology 310 and a second task topology 320. Both the first task topology 310 and the second task topology 320 have dependencies on the first initial task.

In some embodiments, updating at least one initial task in the task orchestration strategy according to the interactive operation of the target object may include: performing intent understanding on an operation information of the interactive operation using the large model, and updating the first initial task related to the operation information in the first task topology.

For example, the first initial task may be a webpage retrieval task, and the operation information may contain an input information indicating “Website A”. The task execution parameter of the webpage retrieval task may be modified based on “Website A”, such that webpage retrieval with respect to “Website A” is added to the execution of the target task, and the obtained target execution result includes webpages in Website A that are related to the demand intent.

According to embodiments of the present disclosure, the feedback information is determined based on the target execution result and an initial execution result of a second initial task in the second task topology. The second initial task in the second task topology among the plurality of task topologies is not affected by the interactive operation. Therefore, while the first initial task is being updated based on the operation information, a plurality of second initial tasks in the second task topology may continue to be executed using the large model, and the feedback information may be generated based on the initial execution result of the second initial tasks and the target execution result. Accordingly, the number of initial tasks to be updated in the task orchestration strategy may be reduced, thereby avoiding redundant computational overhead and waiting time caused by performing full-scale adjustments to the task orchestration strategy to be executed by the large model, improving the response efficiency of providing the feedback information to the target object, and thus enhancing user experience.

In some embodiments, performing semantic understanding on the operation information of the interactive operation using the large model and updating the first initial task related to the operation information of the interactive operation in the first task topology may include: performing semantic understanding on the operation information and the demand information using the large model, so as to obtain a semantic understanding result; and updating a plurality of first initial tasks in the first task topology based on the semantic understanding result.

According to embodiments of the present disclosure, the semantic understanding result may indicate a degree of semantic relevance between the demand information and the operation information. For example, the semantic understanding result may indicate a degree of semantic difference between the operation information and the demand information, a change in the demand intent, a potential demand intent, and the like.

For example, the large model may perform semantic understanding on the demand information “basketball match results” and the operation information “results of yesterday's football league A” of an interactive operation, and determine a semantic understanding result indicating that “the target object is concerned about basketball match results and also wishes to learn about the results of yesterday's football league A”. Accordingly, the semantic understanding result may indicate that the change in the demand intent of the target object may be represented as a shift in the demand from basketball match results to results of football league A, and that the potential demand intent may be represented as an interest in various types of popular sporting events.

Accordingly, the large model may use the semantic understanding result as a prompt information to update the task attribute parameters of the first initial tasks in the first task topology, such that the obtained target task may invoke a retrieval tool to obtain, from authorized match-result websites, basketball match results for the current week and results of football league A for the previous day. In addition, a football match result analysis task may be added to the first task topology as a target task. By executing the target task using the large model, analysis content may be output, where the analysis content may provide a textual analysis of the impact of multiple football match results from the previous day on league rankings of teams in various leagues.

According to embodiments of the present disclosure, by performing semantic understanding on the demand information and the operation information using the large model, the obtained semantic understanding result may represent the degree of semantic relevance between the demand information and the operation information. Accordingly, the large model may synchronously update a plurality of first initial tasks within the same task topology based on the intent related to the actual demand of the target object, such as the potential demand intent and changes in the demand intent represented by the semantic understanding result, thereby improving the accuracy and efficiency of updating the initial tasks. Meanwhile, in the process of updating the first task topology, the second initial tasks in the second task topology may be executed concurrently, thereby avoiding redundant computational overhead and unnecessary waiting time resulting from regeneration of the task orchestration strategy.

In some embodiments, performing intent understanding on the operation information of the interactive operation using the large model and updating the first initial task related to the operation information in the first task topology may include: performing tool invocation intent understanding on the operation information using the first large model based on a tool description prompt, so as to obtain a tool invocation task in the first task topology.

According to embodiments of the present disclosure, the tool description prompt represents a tool description information related to preset tools. The preset tools may include service resources preset in a system, or external service resources that may be invoked under authorized conditions. The tool description information describes information representing the performance of the preset tools, such as a tool parameter range, an applicable scenario, an output result type, and the like.

In some embodiments, the first large model may understand a tool invocation intent contained in the operation information based on the tool performance of the preset tools indicated by the tool description prompt, and may generate, based on the tool invocation intent, a tool invocation task matching the tool invocation intent as a target task, so as to update the first initial task in the first task topology. As a result, the first task topology in the updated task orchestration strategy may more accurately adapt to the actual tool invocation demand of the target object, thereby improving the degree of matching between the target execution result and the demand intent, and further improving the degree of matching between the feedback information and the demand intent, thus enhancing user experience.

According to embodiments of the present disclosure, the tool invocation task instructs the second large model to execute the tool invocation task to invoke a target tool from the preset tool to execute at least one specified task in the first task topology, so as to obtain a target tool execution result for determining the feedback information.

For example, the tool invocation task may be a code editing task. The second large model may invoke a code editing tool as the target tool to perform code editing to execute the specified task, and output a code script matching a task attribute information of the tool invocation task serving as the specified task, where the code script may serve as the target tool execution result. Accordingly, the second large model may execute a code execution task that has a dependency on the code editing task in the first task topology. The second large model may invoke a code execution tool as the target tool to execute the code script, so as to obtain a code execution result as the target tool execution result.

According to embodiments of the present disclosure, by updating the initial tasks in the task orchestration strategy using the first large model, and executing the tool invocation task serving as the target task using the second large model so as to invoke a corresponding target tool to perform the specified task according to the task attribute information of the tool invocation task, it is possible to perform the task orchestration and the tool invocation using a plurality of different large models, and concurrently execute the second initial tasks in the second task topology using the second large model. As a result, the response efficiency to the interactive operation may be improved, and the overall execution efficiency of the task orchestration strategy and the information quality of the target execution result may be enhanced, thereby improving the degree of matching between the feedback information and the demand intent of the target object, and achieving the technical effect of enhancing user experience.

In some embodiments, performing intent understanding on the operation information using the large model and updating the first initial task related to the operation information in the first task topology may further include: performing execution time intent understanding on the operation information based on the tool description prompt using the first large model, so as to obtain a scheduled invocation task.

According to embodiments of the present disclosure, the scheduled invocation task instructs the second large model to invoke a target tool from the preset tool to execute a specified task at a designated time instant or in a designated time period that matches the execution time intent represented by the operation information.

In some embodiments, the execution time intent represented by the operation information may be determined based on key information content contained in the operation information, such as keywords “8:00 PM today”, where the key information content is related to the designated time instant or designated time period.

In some embodiments, the execution time intent may also be determined by performing semantic understanding on the operation information using the first large model. It is possible to determine an invocation time attribute of a tool by understanding the execution time intent implicitly contained in the operation information using the large model, and determine the target tool from the preset tools according to the tool capabilities represented by the tool description information. Accordingly, the first large model may generate a scheduled invocation task that invokes the target tool at a designated time instant or in a designated time period matching the execution time intent, such that the target tool executes the specified task.

For example, the operation information may be “compile the match results of Team A and Team B and generate a standings table”. By performing execution time intent understanding on the operation information using the first large model, it may be determined that the execution time intent in the understanding result lies in that “the match between Team A and Team B that starts at 8:00 PM tonight, and the period between 10:00 PM and 10:20 PM after the match ends”. Accordingly, the scheduled invocation task may be determined to indicate that, between 10:00 PM and 10:20 PM tonight, a retrieval tool is to be invoked to obtain match result information of Team A and Team B from an authorized information interface.

According to embodiments of the present disclosure, by performing semantic understanding on the operation information of the interactive operation and the tool description information in a process of executing an edited task strategy, a scheduled invocation task may be determined. Accordingly, a tool adapted to the target object's demand may be invoked according to the time demand to obtain a tool invocation result, such that the feedback information may accurately satisfy diverse real-time demands of the target object. This avoids delays in obtaining the feedback information that would otherwise occur if the target object had to interact with the large language model again after the designated time instant or designated time period. Furthermore, the scheduled invocation task may intelligently and automatically respond to the delay demand of the target object, thereby enhancing user experience.

In some embodiments, the task orchestration strategy may indicate different processing modes for a plurality of initial tasks or a plurality of target tasks. The processing modes shown in Table 1.1 and Table 1.2 exemplarily illustrate processing modes that may be indicated by the task orchestration strategy.

TABLE 1.1

| Processing Mode | Description of Processing Mode |
|---|---|
| Simple Mode | The simple mode is primarily applied to scenarios where the large model is |
| | not required to perform deep reasoning or complex task execution process, |
| | such as replying to simple questions. |
| | In the simple mode, the large model may perform intent recognition on the |
| | demand information input by the user to determine the demand intent, and a |
| | reasoning model may be invoked to identify the actual question of the user |
| | based on the demand intent and provide a response. This enables rapid |
| | responses to simple demand information of the user without consuming |
| | massive computational resources for complex logical reasoning and |
| | computations. |
| General Mode | The general mode is applicable to single-task scenarios where responses may |
| | be generated through interaction with the large language model using preset |
| | knowledge bases and tool resources. A plurality of initial tasks in the task |
| | orchestration strategy may include intent understanding tasks and tool |
| | invocation tasks, and a specific task may be executed by comprehensively |
| | utilizing various tool resources and storage resources. The specific task in |
| | the general mode may also serve as an initial task in the task orchestration |
| | strategies of the serial mode or parallel mode. |
| Parallel Mode | The parallel mode is applicable for complex task scenarios where tasks may |
| | be executed in parallel to improve execution efficiency. For example, a |
| | plurality of tasks in different task chains in the task orchestration strategy |
| | may be executed in parallel. This achieves simultaneous processing of |
| | multiple tasks, thereby significantly shortening the execution time of the task |
| | orchestration strategy and satisfying the demand intent of the target object |
| | for an efficient output of the feedback information. |
| Intervention | The intervention mode is applicable to scenarios where the target object |
| | needs to perform an interactive operation, such as confirmation, and the |
| Mode | execution continues in response to the interactive operation of the target |
| | object. Furthermore, the intervention mode may be integrated with the |
| | parallel mode or the general mode, or combined with tool resources such as |
| | editors to execute tasks that meet task scenario requirements. |

TABLE 1.2

| Processing Mode | Description of Processing Mode |
|---|---|
| Reflection Mode | The reflection mode is applicable to scenarios where it is needed to |
| | reflect on the execution results of a plurality of initial tasks in the |
| | task orchestration strategy, and adjust the execution process of the |
| | large model according to the reflection results. Through the |
| | reflection mode, the large model is prompted to continuously |
| | optimize the execution process and improve the quality of feedback |
| | information, adapting to various demands of different target objects |
| | as well as complex and dynamic task environments. |
| Scheduled Mode | The scheduled mode is applicable to scenarios where the target |
| | object requires any initial task or target task to be completed within |
| | a specified duration or at a specific time instant. According to a time |
| | instant or time interval preset by the target object, the large model |
| | may be automatically triggered to execute the initial task or target |
| | task, and the large model is prompted to output the initial execution |
| | result or target execution result on schedule, thereby satisfying the |
| | user demand for task time management. |
| | For example, if the first initial task in the task orchestration strategy |
| | depends on key information in Material A, which is only publicly |
| | released at 12:00 PM, a scheduling tool may output a tool invocation |
| | instruction to the large model at 11:58 AM, so as to prompt the large |
| | model to invoke a search tool at the specified release time (12:00 |
| | PM) to execute a material acquisition task, thereby obtaining |
| | Material A from public authorized resource interfaces. |
| Fusion Mode | The fusion mode is applicable to scenarios where the task |
| | orchestration strategy involves a large number of tasks with complex |
| | dependencies, such as a document creation scenario or a music |
| | composition scenario. |
| | The fusion mode may integrate various processing modes, such as |
| | the parallel mode, the reflection mode, and the intervention mode, to |
| | comprehensively monitor, analyze, and adjust the task orchestration |
| | strategy used in the document creation process, so as to ensure |
| | efficient and precise creation of content that satisfies the demand of |
| | the target object, adapting to diverse demands of different target |
| | objects and various changes. |

It should be noted that the processing modes shown in Table 1.1 and Table 1.2 are provided merely to exemplarily illustrate execution processes or application scenarios in which the large model executes the task orchestration strategy, and are not intended to limit the specific scope of the task orchestration strategies provided in embodiments of the present disclosure.

In some embodiments, the information processing method based on a large model may further include: stopping executing at least one initial task in the task orchestration strategy based on the operation information of the interactive operation using a computing unit deploying the large model.

According to embodiments of the present disclosure, the computing unit may include any type of device or component capable of executing computational tasks based on model parameters of the large model, such as a Central Processing Unit (CPU) or a Graphics Processing Unit (GPU).

In some embodiments, upon receiving the operation information, the execution of the initial task using the computing unit according to the model parameters may be suspended, and the initial task indicated by the interactive operation in the task orchestration strategy may be updated according to the task attribute information represented by the operation information, so as to obtain an updated target task. After the target task is obtained, the computing unit may execute the target task according to the model parameters of the large model to obtain a target execution result. Accordingly, redundant computational overhead and excessive waiting time caused by re-performing task orchestration according to the operation information and contextual information to generate a new task orchestration strategy after receiving the operation information may be avoided. By stopping executing the initial task using the computing unit and causing the computing unit to resume execution of the task orchestration strategy after the target task has been updated, computational load on the computing unit may be flexibly controlled in the process of responding to the interactive operation of the target object, thereby reducing computational overhead.

In some embodiments, the orchestration strategy includes a plurality of task topologies having dependencies on a specified initial task, and a stopped-state topology among the plurality of task topologies includes the initial task stopped from being executed.

According to embodiments of the present disclosure, the information processing method based on a large model may further include: executing an initial task in an associated topology using the computing unit in the process of stopping executing the at least one initial task in the task orchestration strategy using the computing unit deploying the large model.

According to embodiments of the present disclosure, the associated topology is another task topology among the plurality of task topologies other than the stopped-state topology.

For example, the associated topology may be a second task topology among the plurality of task topologies that has not yet been updated based on the operation information.

For another example, the associated topology may be a first task topology among the plurality of task topologies that has already been updated in a historical period.

By stopping executing the initial task in the stopped-state topology using the computing unit, it is possible to avoid redundant computational overhead generated by the computing unit that would otherwise be incurred if continuing to execute the stopped-state initial task. Meanwhile, in the process of stopping executing the stopped-state topology by the computing unit, at least one of the initial tasks and the target tasks in the associated topology that are irrelevant to the operation information of the current interactive operation may continue to be executed. This improves the execution efficiency of the task orchestration strategy, thereby enhancing user experience by increasing the response speed of outputting the feedback information.

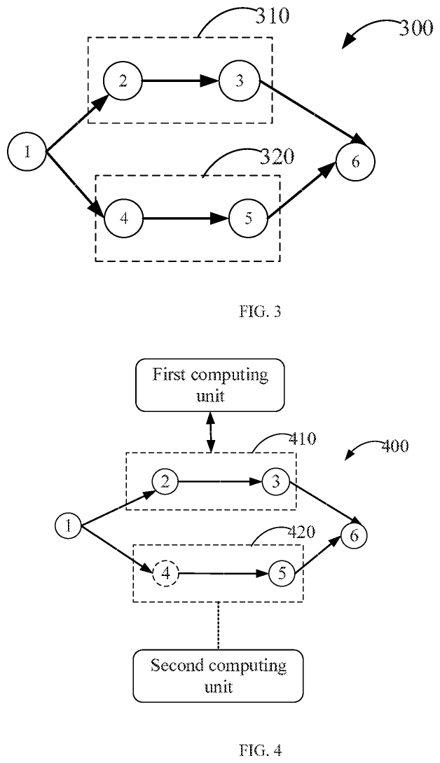

FIG. 4 schematically shows a schematic diagram of a principle of an information processing method based on a large model according to an embodiment of the present disclosure.

As shown in FIG. 4, the task orchestration strategy in such embodiments may be a manuscript task orchestration strategy 400 for generating a match news article. The manuscript task orchestration strategy 400 may include a plurality of initial tasks, which may be represented by the circular elements shown in FIG. 4. The plurality of initial tasks include a first initial task to a sixth initial task. The first initial task represents a manuscript outline generation task, the second initial task represents a match-image material retrieval task, the third initial task represents a match-image material editing task, the fourth initial task represents a match-process text retrieval task, the fifth initial task represents a player data retrieval task, and the sixth initial task represents a manuscript semantic fusion task.

In a case where the target object performs an interactive operation with respect to the fourth initial task and inputs the operation information, a second computing unit may stop executing the fourth initial task. A task topology corresponding to the fourth initial task may be a stopped-state task topology 420. In the process of updating the fourth initial task based on the operation information, a first computing unit may continue to execute the initial tasks in an associated topology 410, so as to retrieve match-image materials in real time and edit the match-image materials. Accordingly, multiple different computing units may be used to dynamically stop executing computation processes corresponding to task topologies, thereby improving the execution efficiency of the manuscript task orchestration strategy 400. In addition, extra computational overhead resulting from re-performing task orchestration may be avoided, and user experience may be enhanced due to reduced computational overhead and lower feedback latency.

In some embodiments, updating at least one initial task in the task orchestration strategy according to the interactive operation of the target object in a process of executing the task orchestration strategy using the large model may further include: updating the initial execution result of the initial task according to the operation information carried by the interactive operation directed to the initial task in a process of executing the task orchestration strategy using the large model, so as to obtain a first target execution result related to the initial task.

According to embodiments of the present disclosure, the first target execution result serves as input data for at least one uncompleted initial task or target task in the orchestration strategy.

For example, the initial execution result may be “match result data of Team A and Team B”. If the match result is reviewed and revised by a referee after the match, the match result data changes. The target object may perform an interactive operation with respect to the revised final match result to modify score data contained in the initial execution result, namely, “match result data of Team A and Team B”, so as to obtain modified final score data as the first target execution result. The final score data may then be input to another initial task having a dependency on the initial task, namely, “analyze the match between Team A and Team B”. Accordingly, the large model may process the “final score data” to output a match analysis text.

According to embodiments of the present disclosure, in a process of executing the task orchestration strategy, the target object may modify the initial execution result of the initial task in real time, and apply the modified target execution result to subsequent initial tasks or target tasks that have not yet been completed. Accordingly, in a process of executing the orchestration strategy, an execution result satisfying the demand of the target object may be obtained in a timely manner through the interactive operation of the target object. In addition, the input data for subsequent initial tasks or target tasks may be adjusted based on the target execution result generated from the operation information, such that the execution result of the orchestration strategy may be adjusted according to the demand of the target object in a timely manner. This improves the degree of matching between the target execution result and the demand intent of the target object, enhances the efficiency of generating the feedback information in a timely and convenient manner, avoids redundant computational overhead and waiting time caused by regenerating task orchestration strategies, and effectively satisfies the actual demand intent of the target object, thereby enhancing user experience.

In some embodiments, updating at least one initial task in the task orchestration strategy according to the interactive operation of the target object in a process of executing the task orchestration strategy using the large model may further include: performing task planning according to the first target execution result and the demand information using the large model, so as to obtain a target task having a dependency on at least one uncompleted initial task.

In an embodiment, in a case where the demand information is “generate a news article regarding a match between Team A and Team B” and the first target execution result is a revised final score of “2:1”, the first large model may perform intent understanding on the demand information and the first target execution result to determine an interaction intent of “the match result has been revised, and a news article needs to be generated according to the new score and the revision process”. The first large model may process the interaction intent to generate a target task of “retrieve real-time commentary text of the match between Team A and Team B”. The target task may then be added to the task orchestration strategy, and the second large model may execute the second target task to obtain a second target execution result of “real-time commentary text of the match”. The second large model may further perform semantic fusion on the second target execution result and the revised first target execution result to obtain a news article reporting on the match after the revision.

According to embodiments of the present disclosure, performing task planning according to the first target execution result and the demand information using the large model may include performing intent understanding on the interactive operation of the target object using the first large model based on the first target execution result generated from the operation information, the demand information, and other contextual content, so as to determine the actual interaction intent of the target object performing the interactive operation. Accordingly, task planning may be performed based on the actual interaction intent determined from the interactive operation of the target object, so as to generate a target task satisfying the actual interaction intent. The modified first target execution result may then be used as input data for the target task, such that the second large model may execute the target task according to the first target execution result. As a result, the target execution result may satisfy the actual interaction intent of the target object, and the degree of matching between the feedback information and the actual demand intent of the target object may be improved. This enables dynamic adjustment of the task orchestration strategy to promptly satisfy the demand of the target object, thereby improving the data quality of the feedback information and enhancing user experience.

In some embodiments, determining the feedback information matching the demand intent of the target object according to the target execution result determined by executing the target task using the large model may include: performing semantic fusion on a plurality of target execution results using the large model according to a style attribute related to the demand information, so as to obtain the feedback information.

According to embodiments of the present disclosure, the style attribute may represent a linguistic expression style of text or copywriting, an image style attribute of an image, a vocalization style attribute of audio data, or the like. The style attribute may be intent content included in the demand intent determined by performing intent understanding on the demand information using the large model, or the style attribute may be information content carried in the demand information. The specific type of the style attribute and the specific manner of determining the style attribute are not limited in embodiments of the present disclosure.

In an embodiment, performing semantic fusion on a plurality of target execution results using the large model may include: performing semantic fusion on a plurality of text segments based on a prompt determined from the style attribute, so as to obtain the feedback information expressed based on the style attribute.

In an embodiment, the style attribute may be information content included in the operation information carried by the interactive operation. By inputting the style attribute through the interactive operation, the target object may adjust the style attribute of the feedback information in real time based on the actual demand, such that the target object may modify the style attribute of the feedback information and the quality of the feedback information through real-time interaction with the large model. This improves the degree of matching between the style attribute of the feedback information and specific scenarios.

In some embodiments, the style attribute may be related to a specified demand scenario. For example, the style attribute may be “a linguistic expression style suitable for presenting and explaining to middle-school students”. Accordingly, the style prompt determined based on the style attribute may be used to prompt the large model to perform stylized semantic fusion on speech segments output from a plurality of target tasks, such that the obtained speech manuscript satisfies the expression style required for the demand scenario of “presenting and explaining to middle-school students”, and the feedback information may match the scenario demand of the target object.

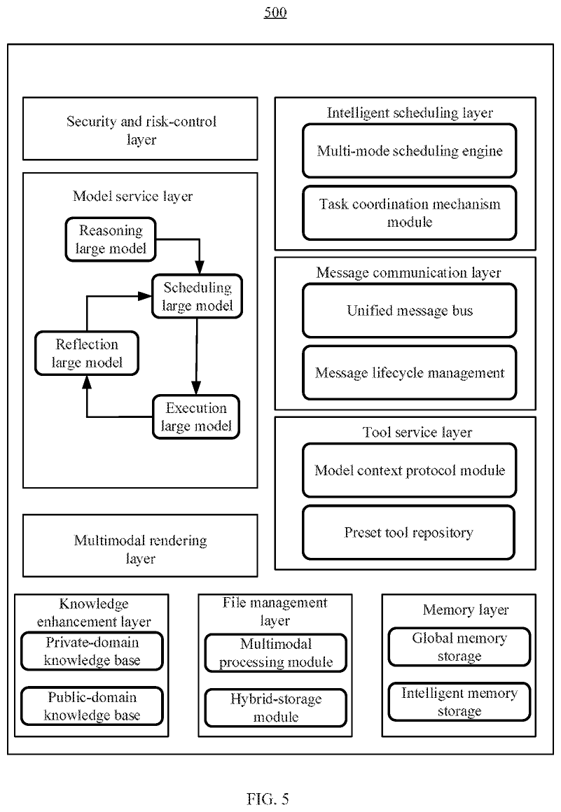

FIG. 5 schematically shows a system architecture diagram of an information processing system according to an embodiment of the present disclosure.

As shown in FIG. 5, an information processing system 500 may implement the information processing method based on a large model provided by embodiments of the present disclosure. The information processing system 500 may include a model service layer, a security and risk-control layer, an intelligent scheduling layer, a message communication layer, a tool service layer, a multimodal rendering layer, a knowledge enhancement layer, a file management layer, and a memory layer.

The model service layer may deploy a plurality of large models for performing the information processing method based on a large model provided by embodiments of the present disclosure. For example, the model service layer may provide a reasoning large model, a scheduling large model, an execution large model, and a reflection large model. The reasoning large model and the scheduling large model may serve as the first large model for executing task orchestration and updating initial tasks, while the execution large model may serve as the second large model for executing initial tasks or target tasks. The reflection large model may inspect initial execution results or target execution results output by the second large model and output a reflection result. Based on the reflection result, the second large model may be iteratively prompted to re-execute initial tasks or target tasks, so as to output a high-quality execution result that satisfies the demand of the target object.

The task orchestration strategy output by the reasoning large model may represent dependencies among a plurality of initial tasks based on topological forms such as a Chain-of-Thought (CoT), a Tree of Thoughts (ToT), or a Graph of Thoughts (GoT). The scheduling large model may select, from a predefined large-model repository, an optimal second large model for executing an initial task or target task, based on a model-routing mechanism. For example, the second large model may be selected based on latency metrics, computational-cost metrics, and accuracy metrics of predefined large models. The reflection large model may establish a multi-dimensional error-classification framework and construct an anomaly-detection matrix according to quality-evaluation options such as logical inconsistencies, factual errors, and task-execution anomalies, so as to evaluate the quality of execution results. Reflection results may then be input as prompt information to the second large model, so as to control the second large model to generate an improved execution result. Accordingly, a closed-loop execution process of reflection-correction-verification may be implemented for the task orchestration strategy. Furthermore, the reflection large model may perform reflective inspection on the execution result based on a public-domain knowledge base or a private-domain knowledge base in the knowledge enhancement layer, thereby improving the accuracy of reflection results.

The scheduling large model may select the processing mode, such as the parallel mode or the serial mode, according to the dependencies indicated by the task orchestration strategy, and schedule the second large model to execute the task orchestration strategy. The scheduling large model may further understand the tool description information and provide tool resources to the execution large model based on a model context protocol. The execution large model may select a target tool based on a plurality of tool description information and invoke the target tool via the model context protocol to execute an initial task or a target task, thereby improving tool invocation accuracy. In addition, the execution large model may perform style-based fusion on the execution result based on the style attribute, such that the style attribute of the feedback information determined from the target execution result satisfies the demand of the target object.

The intelligent scheduling layer may support multiple scheduling modes output by the scheduling large model, such as parallel mode, asynchronous mode, and serial mode, through a multi-mode scheduling engine. The intelligent scheduling layer may further allocate computational resources among multiple computing units or computing devices based on a load-balancing mechanism so as to satisfy execution efficiency requirements of the task orchestration strategy. Furthermore, a task coordination mechanism module of the intelligent scheduling layer may be used for state monitoring and transition throughout the entire lifecycle of initial tasks and target tasks, including creation, execution, suspension, and resumption, and may support functions such as resuming execution from breakpoints.

The message communication layer may establish standardized communication protocols to enable message communication among different large models and between models and tools. The message communication layer may further classify and store messages such as the operation information of the interactive operation of the target object, the execution result output by the large model, and the execution state of the initial task or target task.

The file management layer may parse and store multimodal information such as speech, text, and images through a multimodal processing module. For example, the file management layer may extract semantic features from context based on sliding windows and attention mechanisms, which may be used as input data for the large model in the process of updating the initial task or performing task orchestration. The file management layer may further support information query based on scalar indexes or vector indexes. A hybrid-storage module may implement hierarchical storage, where structured information is stored in scalar storage, semantic information is stored in vector storage, and raw information is stored in object storage. Furthermore, data generated by the large model in execution may be recorded via log files.

The tool service layer may employ a model context protocol module to standardize communications between internal tools and external third-party tool resources. The tool service layer may support protocol-level extensibility for functions such as interaction-data output and integration of large models or intelligent agents. A preset tool repository may be configured with interfaces to various internal tools and external third-party tool resources to enable system invocation.

The tool service layer may further support visual configuration of workflows, intelligent switching between serial mode and parallel mode, as well as configuration of exception handling strategies such as retry, circuit breaking, and degradation. In addition, the tool service layer may monitor metrics such as tool invocation success rate, tool response latency, and resource consumption, while comprehensively recording tool inputs, outputs, and intermediate states.

The memory layer may globally store multi-source data, such as user behavior, dialogue context, and personalized preference attributes, based on graph nodes of a graph neural network. The memory layer may support unified storage and associated retrieval of text, files, and structured data to implement memory storage, and may retrieve stored data using a combination of scalar metadata indexes and vector semantic indexes.

The knowledge base content in the knowledge enhancement layer may support parsing and storage of files in various formats, including text, images, documents, audio, and video. The knowledge enhancement layer may support file-format normalization and multi-dimensional recall based on both scalar and vector dimensions. A public-domain knowledge base may integrate high-quality document resources, real-time Internet data, image-search resources, and multimedia resources. A private-domain knowledge base may support scenario-based knowledge management for scenarios such as repositories, personal knowledge spaces, enterprise cloud drives, and the like.

The security and risk-control layer may support a multi-level defense framework that performs multiple inspections on input information to intercept sensitive information and conducts content-safety reviews on output content based on keywords and risk-control classification models. In addition, manual review may be integrated to intercept anomalous sensitive information. The security and risk-control layer may further support functions such as privacy-data compliance, permission-management frameworks, and audit-trail tracking. The multimodal rendering layer may enable real-time compilation, transcoding, or playback of various types of files.

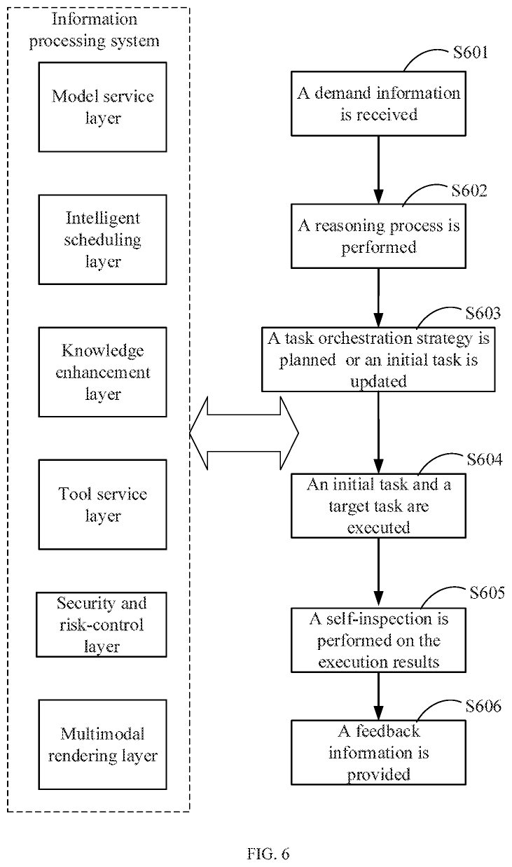

FIG. 6 schematically shows a flowchart of an information processing method based on a large model according to another embodiment of the present disclosure.

As shown in FIG. 6, the information processing method based on a large model in such embodiment may be performed by an information processing system through steps S601 to S606.

In step S601, a demand information is received, and a first large model in a model service layer is invoked to perform step S602. In step S602, a reasoning process is performed according to the demand information to determine a demand intent of a target object.

In step S603, a task orchestration strategy is planned using the first large model, or an initial task is updated according to an interactive operation of the target object.

In step S604, an initial task and a target task are executed using a second large model according to a scheduling strategy provided by an intelligent scheduling layer, so as to obtain an initial execution result and a target execution result. For example, the second large model may invoke a preset tool in a tool service layer to execute a tool invocation task.

In step S605, a self-inspection is performed on the initial execution result and the target execution result using a reflection large model in the model service layer. For example, the execution result may be inspected based on knowledge base content provided by a knowledge enhancement layer, so as to output a reflection result. If the reflection result obtained in step S605 indicates that the self-inspection has passed, a feedback information may be obtained by fusing a plurality of target execution results. Subsequently, step S606 is performed to render the feedback information through a multimodal rendering layer. In the execution of the information processing method, the security and risk-control layer may monitor security risks of the output results and the operation information of the interactive operation in real time to prevent output of sensitive or non-compliant information.

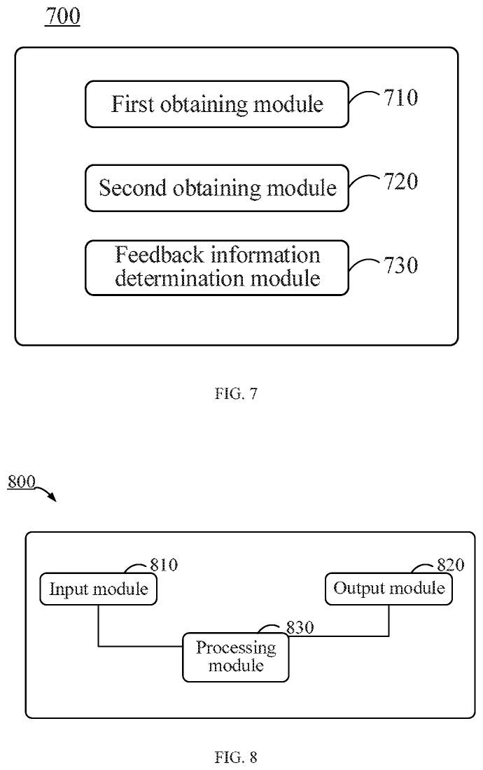

FIG. 7 schematically shows a block diagram of an information processing apparatus based on a large model according to an embodiment of the present disclosure.

As shown in FIG. 7, an information processing apparatus 700 based on a large model includes a first obtaining module 710, a second obtaining module 720, and a feedback information determination module 730.

The first obtaining module 710 is used to perform task orchestration on a demand information related to a target object, so as to obtain a task orchestration strategy including a plurality of initial tasks.

The second obtaining module 720 is used to update at least one initial task in the task orchestration strategy according to an interactive operation of the target object in a process of executing the task orchestration strategy using a large model, so as to obtain a target task.

The feedback information determination module 730 is used to determine a feedback information matching a demand intent of the target object according to a target execution result determined by executing the target task using the large model.

According to embodiments of the present disclosure, the orchestration strategy includes a plurality of task topologies having dependencies on a specified initial task, and the interactive operation is related to a first task topology among the plurality of task topologies. The second obtaining module includes a first updating unit.

The first updating unit is used to perform intent understanding on the operation information of the interactive operation using the large model and update a first initial task related to the operation information in the first task topology, where the feedback information is determined based on the target execution result and an initial execution result of a second initial task in a second task topology.

According to embodiments of the present disclosure, the first updating unit includes a semantic understanding subunit and an updating subunit.

The semantic understanding subunit is used to perform semantic understanding on the operation information and the demand information using the large model, so as to obtain a semantic understanding result, where the semantic understanding result represents a degree of semantic relevance between the demand information and the operation information.

The updating subunit is used to update a plurality of first initial tasks in the first task topology based on the semantic understanding result.

According to embodiments of the present disclosure, the first updating unit includes a tool invocation task obtaining subunit.

The tool invocation task obtaining subunit is used to perform tool invocation intent understanding on the operation information using a first large model based on a tool description prompt, so as to obtain a tool invocation task in the first task topology. The tool description prompt represents a tool description information related to a preset tool, and the tool invocation task instructs a second large model to execute the tool invocation task to invoke a target tool from the preset tool to execute at least one specified task in the first task topology, so as obtain a target tool execution result for determining the feedback information.

According to embodiments of the present disclosure, the first updating unit includes a scheduled invocation task obtaining subunit.

The scheduled invocation task obtaining subunit is used to perform execution time intent understanding on the operation information using the first large model based on the tool description prompt, so as to obtain a scheduled invocation task. The tool description prompt represents a tool description information related to the preset tool, and the scheduled invocation task instructs the second large model to invoke a target tool from the preset tool to execute a specified task at a designated time instant or in a designated time period matching the execution time intent represented by the operation information.

According to embodiments of the present disclosure, the information processing apparatus based on a large model further includes an execution stopping module.

The execution stopping module is used to stop executing at least one initial task in the task orchestration strategy based on the operation information of the interactive operation using a computing unit deploying the large model.

According to embodiments of the present disclosure, the orchestration strategy includes a plurality of task topologies having dependencies on a specified initial task, and a stopped-state topology among the plurality of task topologies includes the initial task stopped from being executed. The information processing apparatus based on a large model further includes an execution module.

The execution module is used to execute an initial task in an associated topology using the computing unit deploying the large model in a process of stopping executing the at least one initial task in the task orchestration strategy using the computing unit, where the associated topology is a task topology among the plurality of task topologies other than the stopped-state topology.

According to embodiments of the present disclosure, the second obtaining module includes a second updating unit.

The second updating unit is used to update an initial execution result of an initial task according to an operation information carried by an interactive operation directed to the initial task in a process of executing the task orchestration strategy using the large model, so as to obtain a first target execution result related to the initial task. The first target execution result serves as input data for at least one uncompleted initial task or target task in the orchestration strategy.

According to embodiments of the present disclosure, the second obtaining module further includes a target task obtaining unit.

The target task obtaining unit is used to perform task planning according to the first target execution result and the demand information using the large model, so as to obtain a target task having a dependency on the at least one uncompleted initial task.

According to embodiments of the present disclosure, the first obtaining module includes a demand intent obtaining unit and a task orchestration strategy obtaining unit.

The demand intent obtaining unit is used to perform semantic understanding on the demand information using the large model, so as to obtain a demand intent.

The task orchestration strategy obtaining unit is used to perform task orchestration based on the demand intent, so as to obtain the task orchestration strategy.

According to embodiments of the present disclosure, the demand intent includes an expected-time intent representing a time expected by the target object to obtain the feedback information, and the task orchestration strategy obtaining unit includes a task orchestration strategy obtaining subunit.

The task orchestration strategy obtaining subunit is used to perform task orchestration on demand content of the demand intent using the first large model based on a latency prompt information determined from the expected-time intent, so as to obtain the task orchestration strategy. A strategy execution duration for the second large model to execute the task orchestration strategy to obtain the feedback information matches the expected-time intent.

According to embodiments of the present disclosure, the information processing apparatus based on a large model further includes a large model determination module.

The large model determination module is used to perform semantic understanding on respective model description information of a plurality of candidate large models using the first large model, based on a task attribute information of the initial task, and determine a second large model for executing the initial task from the plurality of candidate large models. The model description information represents a model performance attribute of the candidate large model.

According to embodiments of the present disclosure, the demand intent obtaining unit includes a first processing subunit.

The first processing subunit is used to perform semantic understanding on the demand information using the large model based on an object attribute knowledge graph, where an object attribute node in the object attribute knowledge graph represents a historical interaction information or an object preference attribute of the target object.

According to embodiments of the present disclosure, the feedback information determination module includes a feedback information obtaining unit used to perform semantic fusion on a plurality of target execution results using the large model according to a style attribute related to the demand information, so as to obtain the feedback information.

According to embodiments of the present disclosure, the information processing apparatus based on a large module further includes a push module.

The push module is used to push at least one of the task orchestration strategy or the initial execution result of the initial task to the target object.

FIG. 8 schematically shows a structural block diagram of an artificial intelligence agent according to an embodiment of the present disclosure.

In embodiments of the present disclosure, as shown in FIG. 8, an artificial intelligence (AI) agent 800 may include an input module 810, a processing module 820, and an output module 830.

The input module 810 is used to receive an input information.

The processing module 820 is used to determine a target task based on the input information received by the input module, determine a large model based on the target task, and obtain an output information by invoking the large model to perform the information processing method based on a large model provided in embodiments of the present disclosure.

The output module 830 is used to output the output information obtained by the processing module.

According to embodiments of the present disclosure, the input module 810 is responsible for receiving or perceiving information such as queries, requests, instructions, signals, or data from the outside world (e.g., a user or an external environment), and converting the received information into a format that can be understood and processed by the AI agent 800. The input module 810 is the primary link for the interaction between the AI agent 800 and the outside world, enabling the AI agent 800 to efficiently and accurately obtain necessary “sensory” information from the outside world and respond to such information.

In an example, the input module 810 may receive the demand information, the operation information of the interactive operation, or the like described above.

In an example, the processing module 820 is the core support for the capabilities of the AI agent 800 to process complex tasks. The processing module 820 may perform the information processing method based on a large model described above.

In an example, the performance of the processing module 820 may be closely related to the large model on which the AI agent 800 is based. In order to fully leverage the capabilities of the large model, the internal structure of the processing module 820 may be designed to be highly configurable and scalable so as to accommodate various types of tasks and demands in real-world scenarios.

In an example, after the demand intent is obtained by the AI agent 800, the processing module 820 may process the demand information using the large model to obtain a task orchestration strategy. The large model may execute the task orchestration strategy and update the initial task according to the interactive operation to obtain a target task. The large model may further process a target execution result to obtain a feedback information and transmit the feedback information to the output module 830.

It may be understood that although large language models possess excellent language understanding and generation capabilities, just like humans, the tasks they can solve are very limited without the aid of any tools. Once the AI agent 800 is endowed with tool invocation capabilities, it can accomplish tasks such as performing mathematical calculations with the aid of a calculator, conducting data analysis with the aid of Python, and retrieving weather forecasts with the aid of a search engine.

In an example, the output module 830 may output the feedback information described above.

The AI agent 800 according to embodiments of the present disclosure may simply and effectively enhance the level of intelligence, and improve flexibility and versatility.

According to embodiments of the present disclosure, the present disclosure further provides an electronic device, a readable storage medium, and a computer program product.

According to embodiments of the present disclosure, an electronic device is provided, including: at least one processor; and a memory communicatively connected to the at least one processor, where the memory stores instructions executable by the at least one processor, and the instructions, when executed by the at least one processor, are used to cause the at least one processor to perform the method described above.

According to embodiments of the present disclosure, a non-transitory computer-readable storage medium having computer instructions therein is provided, where the computer instructions are used to cause a computer to perform the method described above.

According to embodiments of the present disclosure, a computer program product including a computer program is provided, where the computer program, when executed by a processor, is used to perform the method described above.

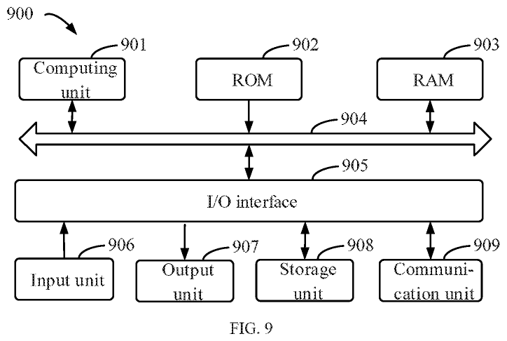

FIG. 9 shows a schematic block diagram of an exemplary electronic device 900 for implementing the information processing method based on a large model in embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 9, the electronic device 900 includes a computing unit 901 which may perform various appropriate actions and processes according to a computer program stored in a Read-Only Memory (ROM) 902 or a computer program loaded from a storage unit 908 into a Random Access Memory (RAM) 903. In the RAM 903, various programs and data necessary for an operation of the electronic device 900 may also be stored. The computing unit 901, the ROM 902 and the RAM 903 are connected to each other through a bus 904. An input/output (I/O) interface 905 is also connected to the bus 904.

A plurality of components in the electronic device 900 are connected to the input/output (I/O) interface 905, including: an input unit 906, such as a keyboard, or a mouse; an output unit 907, such as displays or speakers of various types; a storage unit 908, such as a disk, or an optical disc; and a communication unit 909, such as a network card, a modem, or a wireless communication transceiver. The communication unit 909 allows the electronic device 900 to exchange information/data with other devices through a computer network such as Internet and/or various telecommunication networks.

The computing unit 901 may be various general-purpose and/or dedicated processing assemblies having processing and computing capabilities. Some examples of the computing units 901 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any suitable processor, controller, microcontroller, etc. The computing unit 901 executes various methods and processes described above, such as the information processing method based on a large model. For example, in some embodiments, the information processing method based on a large model may be implemented as a computer software program which is tangibly embodied in a machine-readable medium, such as the storage unit 908. In some embodiments, the computer program may be partially or entirely loaded and/or installed in the electronic device 900 via the ROM 902 and/or the communication unit 909. The computer program, when loaded in the RAM 903 and executed by the computing unit 901, may execute one or more steps in the information processing method based on a large model described above. Alternatively, in other embodiments, the computing unit 901 may be used to perform the information processing method based on a large model by any other suitable means (e.g., by means of firmware).

Various embodiments of the systems and technologies described herein may be implemented in a digital electronic circuit system, an integrated circuit system, a Field Programmable Gate Array (FPGA), an Application Specific Integrated Circuit (ASIC), an Application Specific Standard Product (ASSP), a System On Chip (SOC), a Complex Programmable Logic Device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the data processing method of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a Random Access Memory (RAM), a Read Only Memory (ROM), an Erasable Programmable Read-Only Memory (EPROM or flash memory), an optical fiber, a Compact Disk Read-Only Memory (CD-ROM), an optical storage device, a magnetic storage device, or any suitable combination of the above.

In order to provide interaction with the user, the systems and technologies described here may be implemented on a computer including a display device (for example, CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a Local Area Network (LAN), a Wide Area Network (WAN), and the Internet.

The computer system may include a client and a server. The client and the server are generally far away from each other and usually interact through a communication network. A relationship between the client and the server is generated through computer programs running on the corresponding computers and having a client-server relationship with each other. The server may be a cloud server, a server of a distributed system, or a server incorporating a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. An information processing method based on a large model, the method comprising:
performing task orchestration on a demand information related to a target object to obtain a task orchestration strategy comprising a plurality of initial tasks;
updating at least one of the plurality of initial tasks in the task orchestration strategy according to an interactive operation of the target object in a process of executing the task orchestration strategy using the large model, so as to obtain a target task; and
determining a feedback information matching a demand intent of the target object according to a target execution result determined by executing the target task using the large model.

2. The method of claim 1, wherein the task orchestration strategy comprises a plurality of task topologies having dependencies on a specified initial task, and the interactive operation is related to a first task topology among the plurality of task topologies;
wherein the updating at least one of the plurality of initial tasks in the task orchestration strategy according to an interactive operation of the target object comprises:
performing intent understanding on an operation information of the interactive operation using the large model, and updating a first initial task related to the operation information in the first task topology, and
wherein the feedback information is determined based on the target execution result and an initial execution result of a second initial task in a second task topology.

3. The method of claim 2, wherein the performing intent understanding on an operation information of the interactive operation using the large model and updating a first initial task related to the operation information in the first task topology comprises:
performing semantic understanding on the operation information and the demand information using the large model, so as to obtain a semantic understanding result, wherein the semantic understanding result indicates a degree of semantic relevance between the demand information and the operation information; and
updating a plurality of first initial tasks in the first task topology based on the semantic understanding result.

4. The method of claim 2, wherein the performing intent understanding on an operation information of the interactive operation using the large model and updating a first initial task related to the operation information in the first task topology comprises:
performing tool invocation intent understanding on the operation information based on a tool description prompt using a first large model, so as to obtain a tool invocation task in the first task topology,
wherein the tool description prompt represents a tool description information related to a preset tool, and the tool invocation task instructs a second large model to execute the tool invocation task to invoke a target tool from the preset tool to execute at least one specified task in the first task topology, so as to obtain a target tool execution result for determining the feedback information.

5. The method of claim 2, wherein the performing intent understanding on an operation information of the interactive operation using the large model and updating a first initial task related to the operation information in the first task topology comprises:
performing execution time intent understanding on the operation information based on a tool description prompt using a first large model, so as to obtain a scheduled invocation task,
wherein the tool description prompt represents a tool description information related to a preset tool, and the scheduled invocation task instructs a second large model to invoke a target tool from the preset tool to execute a specified task at a designated time instant or in a designated time period matching an execution time intent represented by the operation information.

6. The method of claim 1, further comprising:
stopping executing at least one initial task in the task orchestration strategy based on an operation information of the interactive operation using a computing unit deploying the large model.

7. The method of claim 6, wherein the task orchestration strategy comprises a plurality of task topologies having dependencies on a specified initial task, and a stopped-state topology among the plurality of task topologies comprises the initial task stopped from being executed;
wherein the method further comprises:
executing an initial task in an associated topology using the computing unit deploying the large model in a process of stopping executing the at least one initial task in the task orchestration strategy using the computing unit deploying the large model, wherein the associated topology is another task topology among the plurality of task topologies other than the stopped-state topology.

8. The method of claim 1, wherein the updating at least one initial task in the task orchestration strategy according to an interactive operation of the target object in a process of executing the task orchestration strategy using the large model comprises:
updating an initial execution result of the initial task according to an operation information carried by the interactive operation directed to the initial task in a process of executing the task orchestration strategy using the large model, so as to obtain a first target execution result related to the initial task, wherein the first target execution result is used as input data for at least one uncompleted initial task or target task in the task orchestration strategy.

9. The method of claim 8, wherein the updating at least one initial task in the task orchestration strategy according to an interactive operation of the target object in a process of executing the task orchestration strategy using the large model further comprises:
performing task planning according to the first target execution result and the demand information using the large model, so as to obtain a target task having a dependency on the at least one uncompleted initial task.

10. The method of claim 1, wherein the performing task orchestration on a demand information related to a target object to obtain a task orchestration strategy comprising a plurality of initial tasks comprises:
performing semantic understanding on the demand information using the large model so as to obtain a demand intent; and
performing task orchestration based on the demand intent to obtain the task orchestration strategy.

11. The method of claim 10, wherein the demand intent comprises an expected-time intent indicating an expected time for the target object to obtain the feedback information;
wherein the performing task orchestration based on the demand intent to obtain the task orchestration strategy comprises:
performing task orchestration on demand content of the demand intent using a first large model, based on a latency prompt information determined from the expected-time intent, so as to obtain the task orchestration strategy, wherein a strategy execution duration for a second large model to execute the task orchestration strategy to obtain the feedback information matches the expected-time intent.

12. The method of claim 10, further comprising:
performing semantic understanding on respective model description information of a plurality of candidate large models using the first large model, based on a task attribute information of the initial task, and
determining, from the plurality of candidate large models, a second large model for executing the initial task,
wherein the model description information represents a model performance attribute of the candidate large model.

13. The method of claim 10, wherein the performing semantic understanding on the demand information using the large model comprises:
performing semantic understanding on the demand information using the large model, based on an object attribute knowledge graph,
wherein an object attribute node in the object attribute knowledge graph represents a historical interaction information of the target object or an object preference attribute of the target object.

14. The method of claim 1, wherein the determining a feedback information matching a demand intent of the target object according to a target execution result determined by executing the target task using the large model comprises:
performing semantic fusion on a plurality of target execution results using the large model according to a style attribute related to the demand information, so as to obtain the feedback information.

15. The method of claim 1, further comprising:
pushing at least one of the task orchestration strategy or an initial execution result of the initial task to the target object.

16. An artificial intelligence agent, comprising:
an input module configured to receive an input information;
a processing module configured to: determine a target task based on the input information received by the input module, determine a large model based on the target task, and obtain an output information by invoking the large model to implement the method of claim 1; and
an output module configured to output the output information obtained by the processing module.

17. An electronic device, comprising:
at least one processor; and
a memory communicatively connected to the at least one processor, wherein the memory stores instructions executable by the at least one processor, and the instructions, when executed by the at least one processor, are configured to cause the at least one processor to at least:
perform task orchestration on a demand information related to a target object to obtain a task orchestration strategy comprising a plurality of initial tasks;
update at least one of the plurality of initial tasks in the task orchestration strategy according to an interactive operation of the target object in a process of executing the task orchestration strategy using the large model, so as to obtain a target task; and
determine a feedback information matching a demand intent of the target object according to a target execution result determined by executing the target task using the large model.

18. The electronic device of claim 17, wherein the task orchestration strategy comprises a plurality of task topologies having dependencies on a specified initial task, and the interactive operation is related to a first task topology among the plurality of task topologies;
wherein the instructions are further configured to cause the at least one processor to at least:
perform intent understanding on an operation information of the interactive operation using the large model, and update a first initial task related to the operation information in the first task topology, and
wherein the feedback information is determined based on the target execution result and an initial execution result of a second initial task in a second task topology.

19. The electronic device of claim 18, wherein the instructions are further configured to cause the at least one processor to at least:
perform semantic understanding on the operation information and the demand information using the large model, so as to obtain a semantic understanding result, wherein the semantic understanding result indicates a degree of semantic relevance between the demand information and the operation information; and
update a plurality of first initial tasks in the first task topology based on the semantic understanding result.

20. A non-transitory computer-readable storage medium having computer instructions therein, wherein the computer instructions are configured to cause a computer to at least:
perform task orchestration on a demand information related to a target object to obtain a task orchestration strategy comprising a plurality of initial tasks;
update at least one of the plurality of initial tasks in the task orchestration strategy according to an interactive operation of the target object in a process of executing the task orchestration strategy using the large model, so as to obtain a target task; and
determine a feedback information matching a demand intent of the target object according to a target execution result determined by executing the target task using the large model.
